(19) United States
(12) Patent Application Publication
(10) Pub. No.: US 2021/0316908 A1
(43) Pub. Date: Oct. 14, 2021

(54) TETHERED PLASTIC STOPPER

(71) Applicant: Novembal USA Inc., Edison, NJ (US)

(72) Inventors: Richard LAMOUREUX, Rawdon (CA); Stéphane GRAUX, Liergues (FR); Henri GRABARCZYK, Gleizé (FR)

(21) Appl. No.: 17/272,116

(22) PCT Filed: Aug. 27, 2019
(86) PCT No.: PCT/US2019/048217

§ 371 Date: Feb. 26, 2021

Related U.S. Application Data
(60) Provisional application No. 62/726,275, filed on Sep. 2, 2018.
(60) Provisional application No. 62/723,457, filed on Aug. 27, 2018.

(51) Int. Cl. B65D 41/34; B65D 55/16; B29C 45/26; B29C 45/72

(52) U.S. Cl. CPC B65D 41/3423; B65D 55/16; B29L 2031/56; B29C 45/7207; B29C 45/26

(57) ABSTRACT

This invention is an improved stopper for a bottle with a tethered plastic stopper where its closure shell remains attached to its tamper band after bottle opening. The tethered plastic stopper includes a closure shell that remains attached to its tamper band after the bottle is opened through a linking feature. The invention also includes a method for making a stopper.

### TECHNICAL FIELD

This invention relates to a method and apparatus for a molded tethered plastic stopper and related molding device.

### BACKGROUND

In the field of liquid packaging, it is very common to seal the aperture of a container with a stopper, often made from a plastic material. Such a container is usually a plastic bottle, but other materials may be used as well.

The stopper typically has a tubular shape closed at its top edge by a top wall. The stopper comprises a closure shell attached to a tamper band through the implementation of bridges. Bridges are distributed around the circumference of the closure shell and the tamper band. Moreover, the bridges may be made when molding the stopper or after through undergoing a cutting step during the manufacturing process.

Usually the bottle neck comprises outer fixation features, such as threads for screw type stopper or annular fixation rings for a snap type stopper that secures the stopper on the bottle neck.

For screw type stoppers, the closure shell typically comprises inner thread(s) arranged inside side walls. The bottle neck fixation feature comprises outer thread(s). Such combinations of outer and inner thread(s) allow the stopper to be screwed on a bottle neck to seal it and unscrewed for bottle entirely opening. A snap type stopper comprises inner annular area and the bottle neck fixation feature comprises outer fixation ring, in order to slot in force the stopper on the bottle neck. A snap type stopper comprises a closure shell with a movable sealing roof from a closed position to a part opening, and reversely. The roof may be separating upon opening or may be connected with the closure shell.

In a bottle sealing position of the stopper, the tamper band is secured around the bottle neck through inner tamper band retaining features or through the tamper band diameter being smaller than a diameter of a tamper evident ring of the bottle neck.

The closure shell is typically removable. During bottle opening, the bridges form a weakness line and are torn apart from the closure shell, so it can be separated from the bottle. The weakness line is torn when user unscrews the closure shell of the stopper or when user lifts the roof by tilting.

There is a recycling risk with separable closure shell as consumers may not always screw or snap back the closure shell onto the bottle neck once empty. The stopper may result in being thrown away in a trash bin as it travels to the landfill environmental considerations.

A solution can be linking the closure shell to the tamper band secured on the bottle neck, so the closure shell stays attached to the bottle after bottle opening. Such an attached stopper is so called a “tethered stopper.”

Other known art prior art systems include a tethered stopper comprising a spiral strip. The spiral strip is made during the stopper molding so there is no cutting or slitting operations. Other known prior art systems includes tethered stoppers comprising two strips linking the closure shell to the tamper band secured on the bottle neck.

### SUMMARY

This invention is an improved stopper for a bottle and an improved method for making the stopper for a bottle with a tethered plastic stopper where its closure shell remains attached to its tamper band after bottle opening. The molding methodology simplifies the mold shells and the way they operate.

The tethered plastic screw stopper can be molded according to a special shape that provides for the stopper extraction after molding. The molded tethered plastic stopper comprises a closure shell with a smaller diameter value than the diameter value of the linking feature. The outer diameter of the closure shell is at least equivalent to the inner diameter of the linking feature. The strip peripherally extends around the circular outer bottom edge of the closure shell. Thus, it is possible to mold the stopper with a plastic stopper molding device comprising at least two shells (top and bottom mold shells).

The top mold shell is standstill and is formed from the heated plastic material injection features. The top mold shell further comprises a bottom inner part shaped to mold the entire outer peripheral faces of the stopper so that the outer peripheral faces the closure shell of the strip and of the tamper band. The bottom mold shell is mobile, moved vertically from an opening to a close molding position, and conversely. The bottom mold shell comprises a top outer part shaped to mold the entire inner faces of the stopper, so the faces inside the closure shell, the inner faces of the linking feature and of the tamper band.

Through the molding process, the bottom mold shell is moved upwardly and its outer shape is determined to manage the formation of the bottom weakness line between the tamper band and the linking feature, as well as the top weakness line between the strip and the closure shell. The bottom weakness line and the top weakness line comprise molded bridges, instead of slits obtained by an additional cutting step.

This invention also involves an improved tethered plastic stopper including a closure shell that remains attached to its tamper band after the bottle is opened through a linking feature.

The linking feature peripherally extends outwardly relative to the closure shell of the stopper at an angle between about 5° and 350°.

According to one embodiment, the linking feature may be a strip surrounding the closure shell. The strip angularly extends from about 5° to 350°, especially at about 270°.

According to another embodiment, the linking feature may include a top hinge attached at the bottom of the closure shell and having its bottom attached at the top of the tamper band. The hinge angularly extends from about 5° to 90°.

The linking feature extends outwardly relative to the closure shell. Hence, because the linking feature has a larger diameter than the outer diameter of the closure shell, it is possible to fabricate the stopper entirely in one molding operation, without further cutting or slitting step.

Other systems, methods, features, and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### DETAILED DESCRIPTION OF THE DRAWINGS

The figures are not necessarily to scale and some features may be exaggerated or minimized, such as to show details of particular components. Emphasis is placed on illustrating the principles of the invention. In the figures, like reference numerals designate corresponding parts throughout the different views.

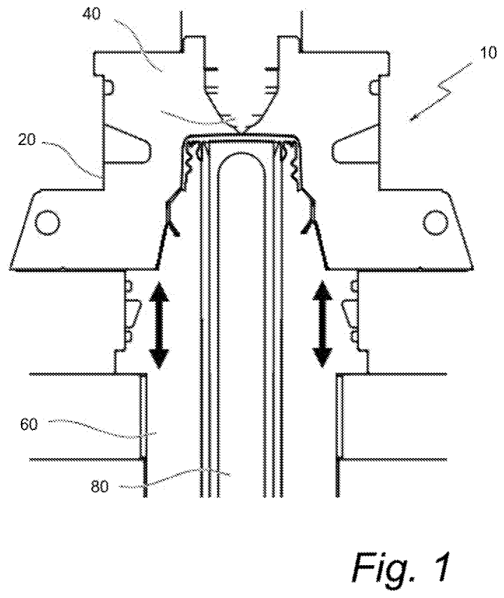

FIG. 1 is a diagrammatic vertical section view of a molding device used for the molding a plastic stopper.

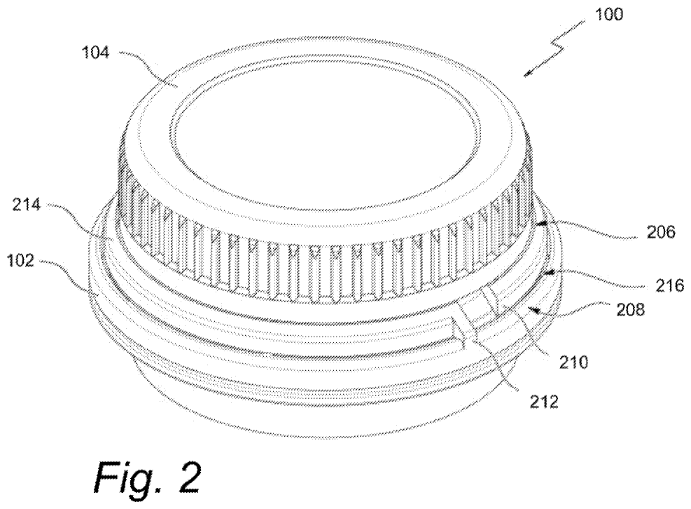

FIG. 2 is a diagrammatic perspective view of a first embodiment of a molded stopper.

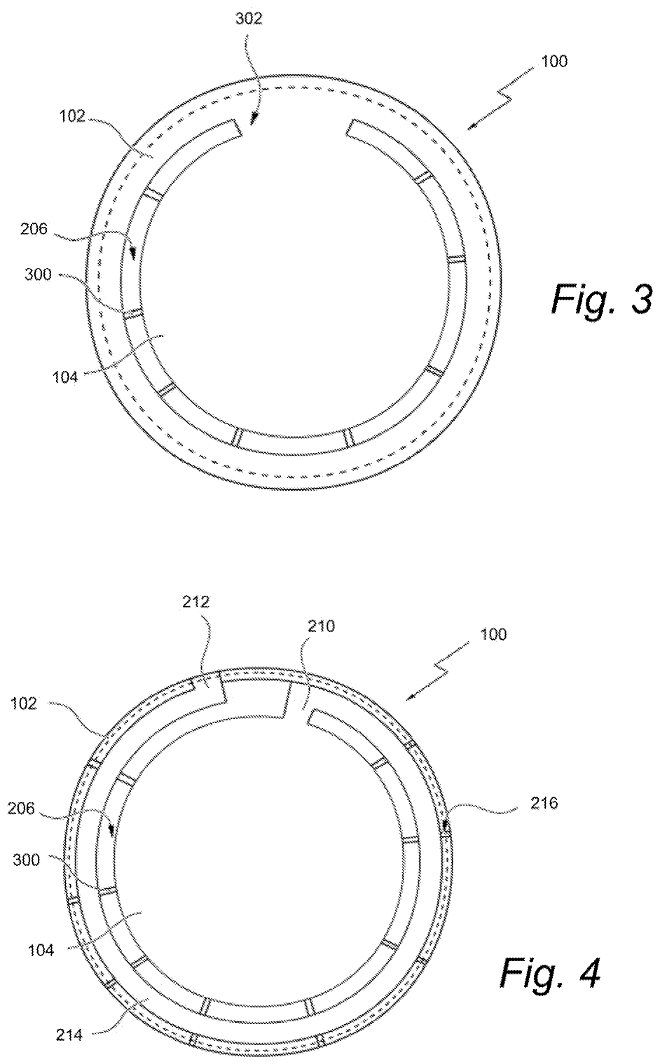

FIG. 3 is a diagrammatic top view section of a first embodiment of a stopper.

FIG. 4 is a diagrammatic top view section of another embodiment of a stopper.

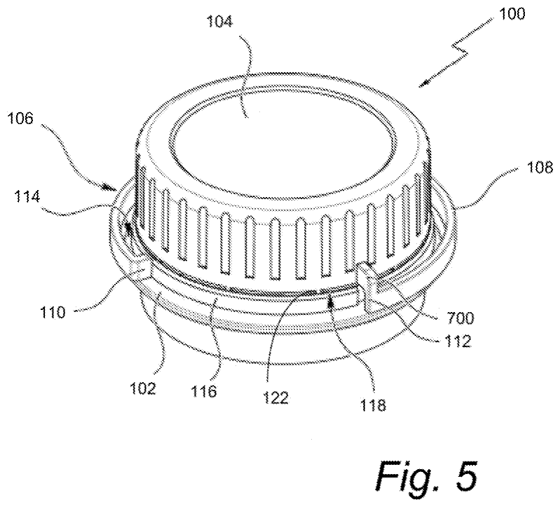

FIG. 5 is a diagrammatic rear view of a another embodiment of the tethered plastic screw stopper in a closed position.

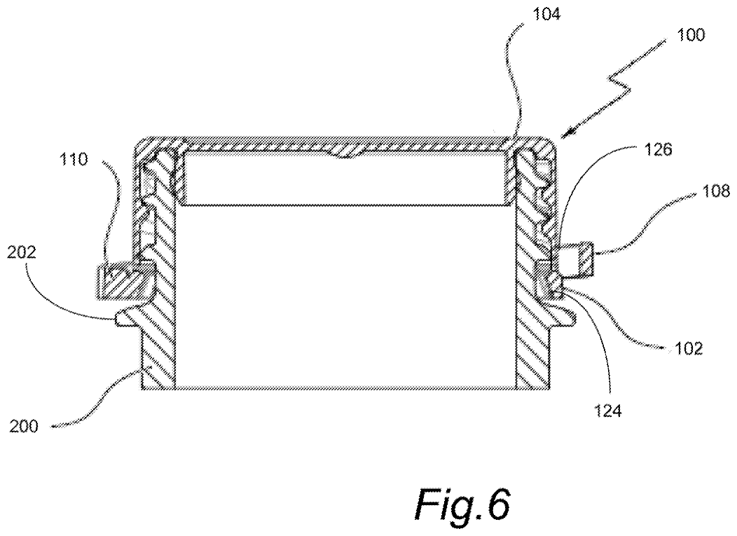

FIG. 6 is a cross section of the stopper of FIG. 5.

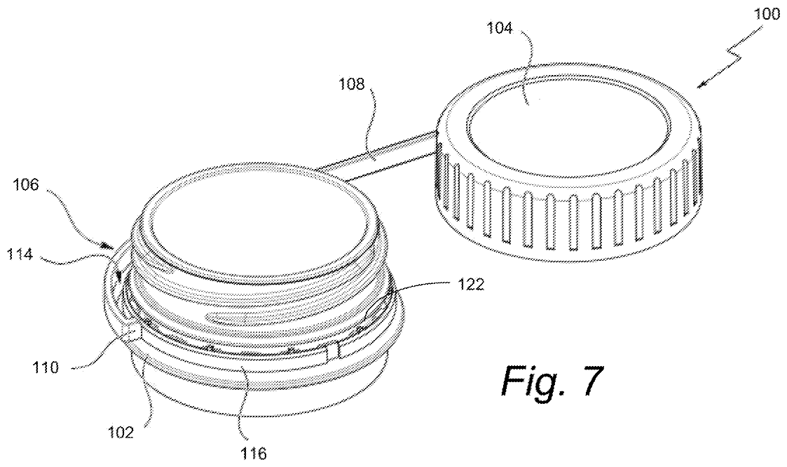

FIG. 7 is a diagrammatic top view of the stopper of FIG. 5 in the opened position.

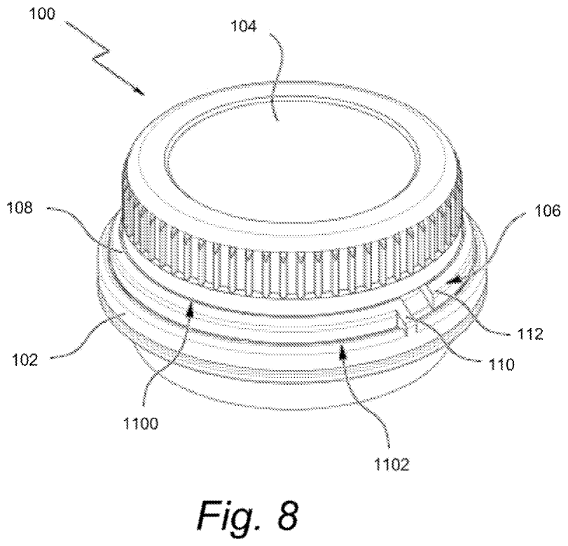

FIG. 8 is a diagrammatic top view section of another embodiment of a stopper.

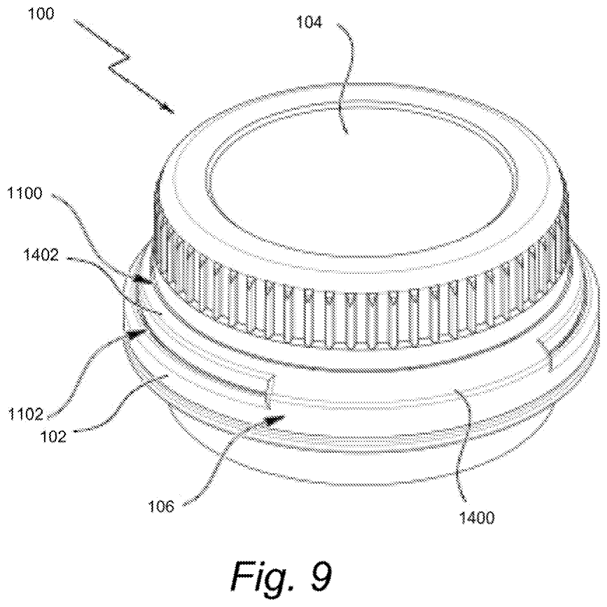

FIG. 9 is a diagrammatic top view section of another embodiment of a stopper.

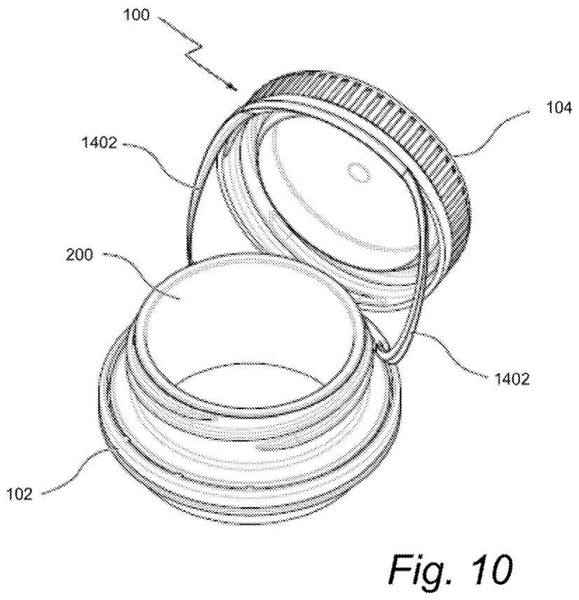

FIG. 10 is a diagrammatic top view of the stopper of FIG. 9 in the opened position.

### DETAILED DESCRIPTION

As required, detailed embodiments of the present disclosure are disclosed herein. The disclosed embodiments are merely examples that may be embodied in various and alternative forms, and combinations thereof. As used herein, for example, exemplary, and similar terms, refer expansively to embodiments that serve as an illustration, specimen, model or pattern.

In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

Phrasing such as ‘configured to’ perform a function, including in the claims, can include any or all of being sized, shaped, positioned in the arrangement, and comprising material to perform the function.

Terms indicating quantity, such as ‘first’ or ‘second’ are used for exemplary and explanation purposes and are not intended to dictate the specific ordering of a component with respect to other components.

Various embodiments of the present disclosure are disclosed herein. The described embodiments are merely exemplary illustrations of implementations set for a clear understanding of the principles of the disclosure. Variations, modifications, and combinations may be made to the described embodiments without departing from the scope of the claims. All such variations, modifications, and combinations are included herein by the scope of this disclosure and the claims.

The invention relates to mold tethered plastic stopper 100. The stopper 100 may be created by molding plastic without the need for an additional manufacturing process step of cutting or slitting the plastic stopper 100 once the plastic stopper 100 is formed. The stopper 100 is used for closing a bottle and has a generally tubular shape. The stopper 100 may be integrally made from one plastic piece by a molding fabrication process. The stopper 100 comprises a tamper band 102 and a closure shell 104. The tamper band 102 and the closure shell 104 are linked together so that the tamper band 102 is positioned top connected around the bottom of the closure shell 104.

At its bottom edge the tamper band 102 are retaining features. The retaining features secure the stopper 100 when sealing the bottle. The retaining features can be formed as a collar. After the collar is inverted inside the tamper band 102 during the bottle sealing process, the collar locks the tamper band 102 and the entire stopper 100 is positioned against a ring managed around the bottle neck.

The stopper 100 is tethered and after opening the closure shell 104 is unremovable from the tamper band 102 and from the bottle once secured to the bottle neck. The first a top weakness line 206 may be created around most of the entire circumference of the stopper 100. However, the weakness line 206 does not necessarily need to extend along at a specific angle so the closure shell 104 can remain attached along an unfree angular segment of the stopper 100 which is a linking feature 208.

The top weakness line 206 may be created between the tamper band 102 and the closure shell 104. The top weakness line 206 may also comprise bridges 300 that are distributed around the tamper band 102 and the closure shell 104. The bridges 300 can be regularly or not regularly distributed around. When the bottle is opened, the bridges 300 are torn apart from the tamper band 102 which is secured on the bottle neck so that the closure shell 104 is separated from the bottle. The top weakness line 206 is torn when the user unscrews the closure shell 104, especially by hand gripping on outer knurls. Meanwhile, the tamper band 102 securely remains on the bottle neck and the closure shell 104 can remains attached to the bottle through the linking feature 208.

In some embodiments (FIG. 3), the linking feature 208 comprises a hinge 302, attached at one top end to the closure shell 104 and at its opposite end to the tamper band 102.

In other embodiments (FIG. 4), the linking feature 208 comprises a top junction 210 connected at a bottom end to the closure shell 104. The linking feature 208 also comprises a strip 214 connected to the opposite end of the top junction 210. Such strip 214 extends almost completely around the stopper 100, attached to the closure shell 104 through the bridges 300 of the top weakness line 206. At the opposite end of the strip 214, the strip 214 is connected to the tamper band 102 through a bottom junction 212. A bottom weakness line 216 connects the bottom edge of the strip 214 and the tamper band 102. The bottom weakness line 216 comprises bridges 300, also regularly or not distributed around the stopper 100. The stopper 100 may be created by a specific molding methodology.

Thus the linking feature 208 has an inner diameter at least greater than the outer diameter of the closure shell 104. The tamper band 102 can have an inner diameter equal or almost equal to the outer diameter of the linking feature 208 or to the outer diameter of the closure shell 104 or to the inner diameter of the closure shell 104.

In some embodiments (FIG. 3) the inner diameter of the linking feature 208 is bigger than the outer diameter of the closure shell 104. The outer diameter of the tamper band 102 (which width is shown in dotted line) is the same as the outer diameter of the linking feature 208.

In some embodiments (FIG. 4) the outer diameter of the strip 214 of the linking feature 208 is smaller than the inner diameter of the tamper band 102, while the inner diameter of the linking feature 208 is greater than the outer diameter of the closure shell 104.

Hence it is possible with such different diameters to change the molding process and the molding device 20.

The molding device 20 comprises a top mold shell 40 that is stationary. The top mold shell 40 comprises a heated plastic injection feature (not shown). The mold device 10 also comprises at least a bottom mold shell 60. The bottom mold shell 60 further comprises a cooling feature 80. The bottom mold shell 60 may be vertically movable upwardly from an opening position to a closed position, and downwardly conversely. The bottom mold shell 60 or the device 20 typically do not comprise any laterally moved mold shell.

In the closed position, the molding device 20 comprises a molding hollow between inner faces of the top mold shell 40 and outer faces of the bottom mold shell 60. The molding hollow may be shaped by the inner face of the top mold shell 40 and the outer face of the bottom shell 60 in the closed position. Thus, the top mold shell 40 inner face at least determines the outer faces of the closure shell 104 and of the tamper band 102. The bottom mold shell 60 outer face determines the inner faces of the closure shell 104 and of the tamper band 20. The strip 108 and the top weakness line 206 and the bottom weakness line 216 are also determined by the respective faces of the top mold shell 40 and the bottom mold shell 60.

In the closes position, the top weakness line 206 is determined between the closure shell 104 and the tamper band 102, through one of the bottom mold shell top faces vertically positioning at least partially in contact with one of the top mold shell bottom faces.

According to another embodiment, when the tamper band 102 is larger than the strip 214, the bottom weakness line 216 is determined between the strip 214 and the tamper band 102, another one of the bottom mold shell top faces is vertically positioned in at least partially contact with another one of the top mold shell bottom faces. A vertical movement of the bottom mold shell 60 is necessary to close the mold hollow of the device 10 and once molded, to extract the stopper 100.

The vertical movement of the bottom shell 60 is possible because of the different diameters of the elements, in order to create the weakness lines 206 and 216. Thus, the bridges 300 of each of the weakness lines 206 and 216 typically do not extend vertically, but horizontally or in an inclined manner. According to the embodiment shown in FIG. 3, the hinge 302 may be created horizontally or in an inclined manner. As shown in FIG. 4, the top junction 210 and the bottom junction 212 of the strip 214 may extend horizontally or in an inclined manner. As shown in FIG. 5, the closure shell 104 has a smaller diameter than the beneath linking feature 208 which has a smaller diameter than beneath the tamper band 102.

As above mentioned the top weakness line 206 separably links the bottom of the closure shell 104 and the top of the tamper band 102 and/or the top of the linking feature 208. According to the specific molding of the invention, the top weakness line 206 outwardly extends horizontally or downwardly relative to the outer face of the closure shell 104.

According to one of the embodiments, the bottom weakness line 216 separably links the bottom of the linking feature 208 to the top of the tamper band 102, the bottom weakness line 216 extending out horizontally and/or downwardly relative to the outer face of the linking feature 208.

According to one of the fabrication processes, the stopper may be molded in one piece. The strip and the weakness lines can be made by an additional cutting operational step during the manufacturing process. According to another fabrication process embodiment, the closure shell, the tamper band and the strip are directly made when molding the stopper. Therefore, the mold comprises several mold shells. A standstill top mold shell through which a heated plastic material is injected into the mold. It comprises two left and right half mold shells that are laterally moved, where the open position of these half mold shells allows the extraction of the stopper once molded. It also comprises an underneath mold shell which is standstill relative to the half mold shells. The top mold shell, the two left and right mold shells and the underneath mold shell determine the outer faces of the hollow of the mold and the outer shape of the stopper to be molded.

The mold further comprises inner mold shells where a central mold shell has a tubular shape and extends vertically, integrating cooling features. Around the central mold shell the inner mold shells also comprises one or two inner peripheral mold shells, mobile or stationary. The central mold shell top and the inner peripheral mold shells determine the inner faces of the hollow of the mold and the inner shape of the stopper to be herein molded.

Such molding process is complex because of the number of mold shells and their movements. Then it takes a predefined molding time because of the time laps for opening and closing the two mobile left and right mold shells and for moving the inner molds shells. Finally, the molded stopper is ejected by force, which causes local plastic deformation on the different element of the stopper.

In some embodiments (FIG. 5), stopper 100 comprises a linking feature 106. The linking feature 106 is attached at a top end to the bottom of the closure shell 104 and its bottom attached at a bottom end to the top of the tamper band 102. Each weakness line 118 of the separation feature 120 does not extend up to each end of the linking feature 106.

In some embodiments of the invention, the linking feature 106 extends outwardly relative to the closure shell 104. So the inner diameter of the linking feature 106 is greater than the outer diameter of the closure shell 104.

According to an embodiment of the invention, the linking feature 106 angularly extends around the closure shell 104. The angular values of the linking feature 106 may vary between 5° and 350°. Such angular variation may be employed for many purposes, especially to allow the closure shell 104 to open and separate from the tamper band 102, when unscrewing or snapping the stopper 100 by the consumer. In addition, the length of the linking feature 106 may be proportional to its angular value, in order to allow for separation of the closure shell 104 at a sufficient distance from the bottle 200 so as not to bother the consumer when drinking.

The linking feature 106 comprises a strip 108. The strip 108 outwardly extends around the stopper 100, and so around the tamper band 102 and the closure shell 104. The strip 108 is attached at a bottom end 110 to the tamper band 102 and at a top opposite end 112 to the closure shell 104. The bottom end 110 and the top end 112 radially extend, in order to manage a gap 114 between the outer face stopper 100 and the inner face of the strip 108, and so between the outer faces of the tamper band 102 and of the closure shell 104. At the bottom end 110, the tamper band 102 comprises a peripherally vertical inner ring 116 to allow the radial bottom end 110 to be attached to the tamper band 102. The top end 112 of the strip 108 is directly attached at a point of the outer face of the closure shell 104. In some embodiments, the top end 112 is higher attached than the bottom end 110, so the strip 108 extends inclined, such as a coil or spiral.

The bottom of the closure shell 104 is attached to the top of the inner ring 116 of the tamper band 102 through the separation feature, which only comprises one weakness line 118 with bridges between the tamper band 102 and the closure shell 104. During opening, the weakness line 118 is torn until totally being disconnected from the tamper band 102 and the closure shell 104.

As above mentioned, the strip 108 angularly extends around the stopper 100 between 5° and 350°. The angular values of the strip 108 may vary between about 5° and 350°. Such angular variation may be employed for many purposes, especially to allow the closure shell 104 to open and separate from the tamper band 104, when unscrewing or snapping the stopper 100 by the consumer. In addition, the length of the strip 108 may be proportional to its angular value, in order to allow for separation of the closure shell 104 at a sufficient distance from the bottle 200 so as not to bother the consumer when drinking

In the embodiments, the strip 108 angularly extends about 270°. So an angular value of about 90° is free around the stopper 100. When opening, the closure shell 104 can be unrolled around the stopper 100 and secured to the bottle 2.

According to a another embodiment (FIG. 5), the top end 112 of the strip 108 comprising a vertical offset 700. So the strip 108 is straight or horizontal relative to the stopper 100.

In a another embodiment (FIG. 10), the strip 108 angularly extends almost all around the stopper 100, making the angular value of the strip 108 about 350°. There is an angular free portion of about 10° between the top end 112 and the bottom end 110 of the strip 108. The strip 108 is attached at its top around the bottom of the closure shell 104 through a top weakness line 1100, and it is attached at its bottom around the top of the tamper band 102 through a bottom weakness line 1102.

In some embodiments (FIG. 5), the strip 108 is located at a top part of the tamper band 102, and capable of vertically extending outwardly. The strip 108 is attached at its first end 126 to a bottom edge of the closure shell 60 and is attached at its second end 124 to a top edge of the tamper band 102. The first end 126 and the second end 124 vertically extend with tangential outer surfaces relative to the closure shell 104. In one embodiment, the first end 126 and the second end 124 vertically extend with tangential outer surfaces relative to also the tamper band 102.

In one embodiment, the diameter of the tamper band 102 is about the same as the diameter of the closure shell 104. For example, the tamper band 102 diameter may be within one or two millimeters (mm) of the diameter of closure shell 104.

In another embodiment, the strip 108 has a diameter that is greater than the diameter of the closure shell 104. For example, the strip 108 diameter may be within 0.5 millimeters to 3 millimeters of the diameter of the closure shell 104.

The stopper 100 may include a top weakness line 114 between the closure shell 106 and the strip 108. The stopper 100 also may include a bottom weakness line 116 between the tamper band 104 and the strip 108.

According to the third embodiment, at least one of the weakness lines, top weakness line 1100 and/or bottom weakness line 1102, includes bridges 1104 distributed around the tamper band 102 and the closure shell 104, spaced apart at regular intervals or not, the bridges 1104 outwardly extending almost horizontally relative to the closure shell 104. During opening, the bottom weakness line 1102 and the top weakness line 1100 are torn until being disconnected from the closure shell 104 and from the tamper band 102. Thus, the strip 108 may then be unrolled around the bottle 200.

In some embodiments (FIG. 8) the linking feature 106 comprises a hinge 1400. The hinge 1400 is attached at its bottom to the tamper band 102. The hinge 1400 is attached at its top to an annular band 1402. The annular band 1402 is attached at its top around most of the periphery of the closure shell 104 through a top weakness line 1100, and the annular band 1402 is attached at its bottom around most the periphery of the tamper band 102 through a bottom weakness line 1102.

The hinge 1400 angularly extends from about 5° to 90°. So the bottom weakness line 1102 angularly extends from about 270° to 355°, respectively to the angle value of the hinge 1400. The top weakness line 1100 angularly extends along the annular band 1402, from about 5° to 350°. So an unseparated portion of the annular band 1402 remains attached at the closure shell 104. The top weakness line 1100 extends over the hinge 1400. The unseparated portion of the annular band 1402 is opposite to the hinge 1400. The angular value of the top weakness line 1100 allows the closure shell 104 to be moved when opening at a sufficient distance to be separated from the bottle 200. When opening, the hinge 1400 retains the annular band 1402 to the tamper band 102 and the annular band 1402 retains the closure shell 104, which can be laterally moved to the side of the hinge 1400.

In an embodiment, the stopper 100 may include a transversal weakness portion 120 extending from the top weakness line 114 to the bottom weakness line 116. The weakness portion 120 separates the ends (124, 126) of the linking feature 108. The weakness portion 120 may extend vertically or almost vertically, or may be inclined.

According to an embodiment, each of the weakness lines 114, 116 and/or the weakness portion 120 may be made by bridges, respectively connecting the linking feature 108, the closure shell 106 and the tamper band 104. The bridges are distributed along each weakness lines 114, 116, spaced apart regularly or not. Thus, when opening the closure shell 106, the bridges are torn apart from the closure shell 106 and/or from the tamper band 104.

According to another embodiment, the width of each of the weakness lines 114, 116 and/or the weakness portion 120 may be thinner than the closure shell 106 and/or the tamper band 104. According to another embodiment, each of the weakness lines 114, 116 and/or the weakness portion 120 may be made when molding the stopper 100 or after through a cutting or slitting step.

At its bottom edge the tamper band 104 comprises retaining features. The retaining features secure the stopper 100 when sealing the bottle neck 200. The retaining features are made of a collar. Usually, after the collar being inverted inside the tamper band 104, when the bottle 200 is sealed the collar locks the tamper band 104 and the entire stopper 100 against a tampering by extending outwardly around the bottle neck 200.

Before opening, the closure shell 106 is unremovable from the tamper band 104, secured to the bottle neck 200. Upon opening, the weakness lines 114, 116 break, allowing the closure shell 106 to be separated from the bottle neck 100, to allow drinking. When opening, the strip 108 is separated by breaking the weakness lines 114, 116 at the transversal weakness portion 120, allowing the strip 108 to be unrolled (e.g., FIG. 7). However, the strip 108 remains attached at its first end 126 the closure shell 106 and at its second end 124 to the tamper band 104, permitting the entire bottle system to be disposed at the same time.

In one embodiment, the strip 108 has an outer diameter about equivalent to the outer diameter of the closure shell 106. Because the strip 108 does not extend significantly outside the closure shell 106. The strip 108 outer diameter may also be about the same size as the outer diameter of the tamper band 104. The entire tethered stopper 100 may have a globally a tubular shape in closed position, such as that shown in FIGS. 1 and 2.

While various embodiments of the invention have been described, it will be apparent to those of ordinary skill in the art that many more embodiments and implementations are possible that are within the scope of this invention.

What is claimed is:

1. A method for molding a tethered plastic stopper for closing a bottle, comprising:
moving a bottom mold shell is vertically and upwardly to a standstill top mold shell in a closed position;
determining a mold hollow between the inner faces of the top mold shell and the outer faces of the bottom mold shell here the mold hollow is shaped as the form of the plastic screw stopper to he molded and where the mold hollow is shaped by the inner face of the top mold shell and the outer face of the bottom shell in the closed position;
determining the top mold shell inner face, the outer faces of a closure shell and of a tamper band of the stopper;
determining the bottom mold shell outer face and the inner faces of the closure shell and of the tamper band when in the closed position;
determining at least a top weakness line between the closure shell and the tamper band, through one of the bottom mold shell top faces vertically positioning, at least partially in contact with one of the top mold, shell bottom litres;
heating plastic material is injected into the mold hollow through the, top mold shell;
cooling the injecting plastic material through the bottom mold shell;
moving the bottom mold shell vertically and downwardly into an open position; and
ejecting the plastic stopper from the top mold shell.

2. The method for molding a tethered plastic stopper for closing a bottle according to claim 1, further comprising:
forming a bottom weakness line between a linking feature and the tamper band; and
positioning one of the bottom mold shell top faces is vertically in at least partially contact with another one of the top mold shell bottom faces.

3. A molding device for molding a tethered plastic stopper, comprising
a top mold shell being standstill; and
as bottom mold shell vertically movable upwardly from an opening position to a closed position and downwardly to a closed position;
in the closed position, the molding device comprises a molding hollow between inner faces of the top mold shell and outer faces of the bottom mold shell, where the top mold, shell comprises heated plastic injection features, the bottom mold shell comprises cooling feature, and where the molding hollow is shaped by the inner face of the top mold shell and the outer face of the bottom shell in the closed position;
the top mold shell inner face determining the outer faces of a closure shell and of a tamper band of a stopper and the bottom mold shell outer face determining the inner faces of the closure shell and of the tamper and; and
when in the closed position, at least a top weakness line is determined between the closure shell and the tamper band, through one of the bottom mold shell top faces vertically positioning at least partially in contact with one of the top mold shell bottom faces.

4. A tethered molded plastic stopper for closing a bottle, comprising
a tamper band;
a closure shell; and
a linking feature between the tamper band and the closure shell, where the tamper band and the closure shell being connected through the linking feature, and the closure shell further comprises an outer diameter value at least equivalent to the inner diameter value of the linking feature.

5. A tethered molded plastic screw stopper according to claim 4, when the tamper band comprises an inner diameter value at least equivalent to the outer diameter value of the linking feature.

6. A tethered molded plastic screw stopper according to claim 4, where the tamper hand comprises an inner diameter value inferior to the outer diameter value of the linking feature.

7. A tethered molded plastic screw stopper according to claim 4, where the plastic screw stopper further comprises a top weakness line separably connecting the bottom of the closure shell and the top of the tamper band and/or the top of the linking feature, the top weakness line outwardly extending horizontally or downwardly relative to the outer face of the closure shell.

8. A tethered molded plastic screw stopper according to claim 7, where the plastic screw stopper further comprises a bottom weakness line separably connecting the bottom of the linking feature to the top of the tamper band, the bottom weakness line extending out horizontally and/or downwardly relative to the outer face of the linking feature.

9. A tethered plastic stopper, comprising
a tamper band positioned around the stopper;
a closure shell positioned on top of the stopper above the tamper band, and
a linking feature connecting the tamper band to the closure shell;
where the linking is attached at its top to the closure shell and at its bottom to the tamper band, and
where the linking feature is capable of extending angularly between about 5° to 350°.

10. The tethered plastic stopper according to claim 9, where the linking feature extends outwardly around the closure shell.

11. The tethered plastic stopper according to claim 10, where the linking feature further includes a strip attached at a bottom end to the tamper band and at a top end to the closure shell, the strip angularly extends about 270°.

12. The tethered plastic stopper according to claim 11, where the tamper band comprises ,a peripherally vertical annular inner ring and the bottom end of the strip is radially attached to the inner ring.

13. The tethered plastic stopper according to claim 10, where the linking feature further includes a weakness line between the tamper band and the closure shell.

14. The tethered plastic stopper according to, claim 9, where the linking feature further includes a hinge which angularly extends between about 5° and 90°.

15. A tethered plastic stopper, comprising
a tamper band having a diameter and positioned around the stopper;
a closure shell having a diameter and a bottom portion and positioned on top of the stopper above the tamper band,
a linking feature connecting the tamper band to the closure shell;
where the linking feature is attached at a first end to the closure shell and at a second end to the tamper band;
where the linking feature extends around most of the closure shell; and
where the linking feature has a diameter similar to the diameter of the closure shell.

16. The tethered plastic stopper according to claim 15, where the diameter of the linking, feature is similar to the diameter of the tamper band.

17. The tethered plastic stopper according to claim 15, where the diameter of the linking feature is greater than the diameter of the closure shell by about 0.5 mm to 3 mm.
